(19) United States
(12) Patent Application Publication
(10) Pub. No.: US 2022/0351626 A1
(43) Pub. Date: Nov. 3, 2022

(54) MULTI-OBJECTIVE MISSION PLANNING AND EXECUTION FOR AN UNMANNED AERIAL VEHICLE

(71) Applicant: SKYGRID, LLC, Austin, TX (US)

(72) Inventors: SYED MOHAMMAD ALI, LEANDER, TX (US); LOWELL L. DUKE, AUSTIN, TX (US); ZEHRA AKBAR, LEANDER, TX (US); SYED MOHAMMAD AMIR HUSAIN, GEORGETOWN, TX (US); TAYLOR R. SCHMIDT, AUSTIN, TX (US); MILTON LOPEZ, ROUND ROCK, TX (US); RAVI TEJA PINNAMANENI, AUSTIN, TX (US)

(21) Appl. No.: 17/733,029

(22) Filed: Apr. 29, 2022

Related U.S. Application Data
(60) Provisional application No. 63/181,265, filed on Apr. 29, 2021.

(51) Int. Cl. G08G 5/00; B64C 39/02

(52) U.S. Cl. CPC G08G 5/003; G08G 5/006; G08G 5/0069; B64C 39/024; B64C 2201/126; B64C 2201/145

(57) ABSTRACT

Methods, systems, apparatuses, and computer program products for multi-objective mission planning and execution for an unmanned aerial vehicle (UAV) are disclosed. In a particular embodiment, multi-objective mission planning and execution for a UAV includes a computing device detecting a mode change event associated with a UAV executing a mission in a first mission mode. In this embodiment, the computing device determines, based on the mode change event, a second mission mode for the UAV and switches a current mission mode of the UAV from the first mission mode to the second mission mode.

### CROSS-REFERENCE TO RELATED APPLICATIONS

This application is a non-provisional application for patent entitled to a filing date and claiming the benefit of earlier-filed U.S. Provisional Patent Application Ser. No. 63/181,265, filed Apr. 29, 2021, the contents of which are incorporated by reference herein in their entirety.

### BACKGROUND

An Unmanned Aerial Vehicle (UAV) is a term used to describe an aircraft with no pilot on-board the aircraft. The use of UAVs is growing in an unprecedented rate, and it is envisioned that UAVs will become commonly used for package delivery and passenger air taxis. However, as UAVs become more prevalent in the airspace, there is a need to regulate air traffic and ensure the safe navigation of the UAVs.

The Unmanned Aircraft System Traffic Management (UTM) is an initiative sponsored by the Federal Aviation Administration (FAA) to enable multiple beyond visual line-of-sight drone operations at low altitudes (under 400 feet above ground level (AGL)) in airspace where FAA air traffic services are not provided. However, a framework that extends beyond the 400 feet AGL limit is needed. For example, unmanned aircraft that would be used by package delivery services and air taxis may need to travel at altitudes above 400 feet. Such a framework requires technology that will allow the FAA to safely regulate unmanned aircraft.

### SUMMARY

Methods, systems, apparatuses, and computer program products for multi-objective mission planning and execution for an unmanned aerial vehicle (UAV) are disclosed. In a particular embodiment, multi-objective mission planning and execution for a UAV includes a computing device detecting a mode change event associated with a UAV executing a mission in a first mission mode. In this embodiment, the computing device determines, based on the mode change event, a second mission mode for the UAV and switches a current mission mode of the UAV from the first mission mode to the second mission mode.

In a particular embodiment, multi-objective mission planning and execution for a UAV includes a computing device determining a plurality of mission modes for a UAV to perform during execution of a mission. In this embodiment, the computing device generates at least one flight path linking a first mission mode of the plurality of mission modes to a second mission mode of the plurality of mission modes and generates multi-objective mission route information including the at least one flight path and the plurality of mission modes of the UAV.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a block diagram illustrating a particular implementation of a system for multi-objective mission planning and execution for an unmanned aerial vehicle;

FIG. 2 is a block diagram illustrating another implementation of a system for multi-objective mission planning and execution for an unmanned aerial vehicle;

FIG. 3A a block diagram illustrating a particular implementation of the blockchain used by the systems of FIGS. 1-2 to record data associated with an unmanned aerial vehicle;

FIG. 3B is an additional view of the blockchain of FIG. 3A;

FIG. 3C is an additional view of the blockchain of FIG. 3A;

FIG. 4 is a diagram to illustrate an example mission mode for an unmanned aerial vehicle;

FIG. 5 is a diagram to illustrate an example mission mode for an unmanned aerial vehicle;

FIG. 6 is a diagram to illustrate an example mission mode for an unmanned aerial vehicle;

FIG. 7 is a diagram to illustrate an example mission mode for an unmanned aerial vehicle;

FIG. 8 is a flowchart to illustrate an implementation of a method for multi-objective mission planning and execution for an unmanned aerial vehicle;

FIG. 9 is a flowchart to illustrate an implementation of a method for multi-objective mission planning and execution for an unmanned aerial vehicle;

FIG. 10 is a flowchart to illustrate an implementation of a method for multi-objective mission planning and execution for an unmanned aerial vehicle;

FIG. 11 is a flowchart to illustrate an implementation of a method for multi-objective mission planning and execution for an unmanned aerial vehicle;

FIG. 12 is a flowchart to illustrate an implementation of a method for multi-objective mission planning and execution for an unmanned aerial vehicle; and

FIG. 13 is a flowchart to illustrate an implementation of a method for multi-objective mission planning and execution for an unmanned aerial vehicle.

### DETAILED DESCRIPTION

Particular aspects of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

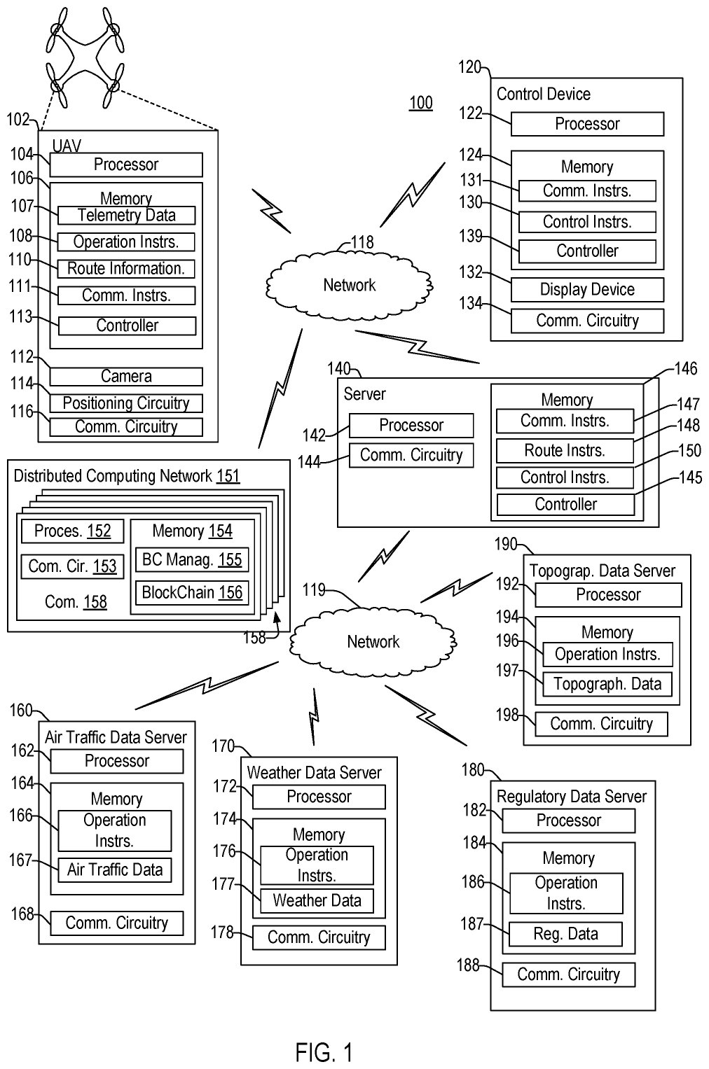

Exemplary methods, apparatuses, and computer program products for multi-objective mission planning and execution for an Unmanned Ariel Vehicle (UAV) in accordance with the present invention are described with reference to the accompanying drawings, beginning with FIG. 1. FIG. 1 sets forth a diagram of a system 100 configured for multi-objective mission planning and execution for a UAV according to embodiments of the present disclosure. The system 100 of FIG. 1 includes an unmanned aerial vehicle (UAV) 102, a control device 120, a server 140, a distributed computing network 151, an air traffic data server 160, a weather data server 170, a regulatory data server 180, and a topographical data server 190.

A UAV, commonly known as a drone, is a type of powered aerial vehicle that does not carry a human operator and uses aerodynamic forces to provide vehicle lift. UAVs are a component of an unmanned aircraft system (UAS), which typically include at least a UAV, a control device, and a system of communications between the two. The flight of a UAV may operate with various levels of autonomy including under remote control by a human operator or autonomously by onboard or ground computers. Although a UAV may not include a human operator pilot, some UAVs, such as passenger drones drone taxi, flying taxi, or pilotless helicopter carry human passengers.

For ease of illustration, the UAV 102 is illustrated as one type of drone. However, any type of UAV may be used in accordance with embodiments of the present disclosure and unless otherwise noted, any reference to a UAV in this application is meant to encompass all types of UAVs. Readers of skill in the art will realize that the type of drone that is selected for a particular mission or excursion may depend on many factors, including but not limited to the type of payload that the UAV is required to carry, the distance that the UAV must travel to complete its assignment, and the types of terrain and obstacles that are anticipated during the assignment.

In FIG. 1, the UAV 102 includes a processor 104 coupled to a memory 106, a camera 112, positioning circuitry 114, and communication circuitry 116. The communication circuitry 116 includes a transmitter and a receiver or a combination thereof (e.g., a transceiver). In a particular implementation, the communication circuitry 116 (or the processor 104) is configured to encrypt outgoing message(s) using a private key associated with the UAV 102 and to decrypt incoming message(s) using a public key of a device (e.g., the control device 120 or the server 140) that sent the incoming message(s). As will be explained further below, the outgoing and incoming messages may be transaction messages that include information associated with the UAV. Thus, in this implementation, communications between the UAV 102, the control device 120, and the server 140 are secure and trustworthy (e.g., authenticated).

The camera 112 is configured to capture image(s), video, or both, and can be used as part of a computer vision system. For example, the camera 112 may capture images or video and provide the video or images to a pilot of the UAV 102 to aid with navigation. Additionally, or alternatively, the camera 112 may be configured to capture images or video to be used by the processor 104 during performance of one or more operations, such as a landing operation, a takeoff operation, or object/collision avoidance, as non-limiting examples. Although a single camera 112 is shown in FIG. 1, in alternative implementations more and/or different sensors may be used (e.g., infrared, LIDAR, SONAR, etc.).

The positioning circuitry 114 is configured to determine a position of the UAV 102 before, during, and/or after flight. For example, the positioning circuitry 114 may include a global positioning system (GPS) interface or sensor that determines GPS coordinates of the UAV 102. The positioning circuitry 114 may also include gyroscope(s), accelerometer(s), pressure sensor(s), other sensors, or a combination thereof, that may be used to determine the position of the UAV 102.

The processor 104 is configured to execute instructions stored in and retrieved from the memory 106 to perform various operations. For example, the instructions include operation instructions 108 that include instructions or code that cause the UAV 102 to perform flight control operations. The flight control operations may include any operations associated with causing the UAV to fly from an origin to a destination. For example, the flight control operations may include operations to cause the UAV to fly along a designated route (e.g., based on route information 110, as further described herein), to perform operations based on control data received from one or more control devices, to take off, land, hover, change altitude, change pitch/yaw/roll angles, or any other flight-related operations. The UAV 102 may include one or more actuators, such as one or more flight control actuators, one or more thrust actuators, etc., and execution of the operation instructions 108 may cause the processor 104 to control the one or more actuators to perform the flight control operations. The one or more actuators may include one or more electrical actuators, one or more magnetic actuators, one or more hydraulic actuators, one or more pneumatic actuators, one or more other actuators, or a combination thereof.

The route information 110 may indicate a flight path for the UAV 102 to follow. For example, the route information 110 may specify a starting point (e.g., an origin) and an ending point (e.g., a destination) for the UAV 102. Additionally, the route information may also indicate a plurality of waypoints, zones, areas, regions between the starting point and the ending point. The route information 110 may include a plurality of mission modes and flight paths linking the mission modes to one another.

The route information 110 may also indicate a corresponding set of control devices for various points, zones, regions, areas of the flight path. The indicated sets of control devices may be associated with a pilot (and optionally one or more backup pilots) assigned to have control over the UAV 102 while the UAV 102 is in each zone. The route information 110 may also indicate time periods during which the UAV is scheduled to be in each of the zones (and thus time periods assigned to each pilot or set of pilots).

The memory 106 of the UAV 102 also includes a mission controller 113 configured for multi-objective mission planning and execution. In a particular embodiment, the mission controller 113 includes computer program instructions that when executed by the processor 104 cause the processor 104 to carry out the operations of: detecting a mode change event associated with a UAV executing a mission in a first mission mode; determining based on the mode change event, a second mission mode for the UAV; and switching a current mission mode of the UAV from the first mission mode to the second mission mode. In a particular embodiment, the mission controller 113 includes computer program instructions that when executed by the processor 104 cause the processor 104 to carry out the operations of: determining a plurality of mission modes for a UAV to perform during execution of a mission; generating at least one flight path linking a first mission mode of the plurality of mission modes to a second mission mode of the plurality of mission modes; and generating multi-objective mission route information including the at least one flight path and the plurality of mission modes of the UAV.

In the example of FIG. 1, the memory 106 of the UAV 102 also includes communication instructions 111 that when executed by the processor 104 cause the processor 104 to transmit to the distributed computing network 151, transaction messages that include telemetry data 107. Telemetry data may include any information that could be useful to identifying the location of the UAV, the operating parameters of the UAV, or the status of the UAV. Examples of telemetry data include but are not limited to GPS coordinates, instrument readings (e.g., airspeed, altitude, altimeter, turn, heading, vertical speed, attitude, turn and slip), and operational readings (e.g., pressure gauge, fuel gauge, battery level).

The control device 120 includes a processor 122 coupled to a memory 124, a display device 132, and communication circuitry 134. The display device 132 may be a liquid crystal display (LCD) screen, a touch screen, another type of display device, or a combination thereof. The communication circuitry 134 includes a transmitter and a receiver or a combination thereof (e.g., a transceiver). In a particular implementation, the communication circuitry 134 (or the processor 122 is configured to encrypt outgoing message(s) using a private key associated with the control device 120 and to decrypt incoming message(s) using a public key of a device (e.g., the UAV 102 or the server 140 that sent the incoming message(s). Thus, in this implementation, communication between the UAV 102, the control device 120, and the server 140 are secure and trustworthy (e.g., authenticated).

The processor 122 is configured to execute instructions from the memory 124 to perform various operations. The instructions also include control instructions 130 that include instructions or code that cause the control device 120 to generate control data to transmit to the UAV 102 to enable the control device 120 to control one or more operations of the UAV 102 during a particular time period, as further described herein.

The memory 124 of the control device 120 also includes a mission controller 139 configured for multi-objective mission execution. In a particular embodiment, the mission controller 139 includes computer program instructions that when executed by the processor 122 cause the processor 122 to carry out the operations of: detecting a mode change event associated with a UAV executing a mission in a first mission mode; determining based on the mode change event, a second mission mode for the UAV; and switching a current mission mode of the UAV from the first mission mode to the second mission mode. In a particular embodiment, the mission controller 139 includes computer program instructions that when executed by the processor 122 cause the processor 122 to carry out the operations of: determining a plurality of mission modes for a UAV to perform during execution of a mission; generating at least one flight path linking a first mission mode of the plurality of mission modes to a second mission mode of the plurality of mission modes; and generating multi-objective mission route information including the at least one flight path and the plurality of mission modes of the UAV.

In the example of FIG. 1, the memory 124 of the control device 120 also includes communication instructions 131 that when executed by the processor 122 cause the processor 122 to transmit to the distributed computing network 151, transaction messages that include control instructions 130 that are directed to the UAV 102. In a particular embodiment, the transaction messages are also transmitted to the UAV and the UAV takes action (e.g., adjusting flight operations), based on the information (e.g., control data) in the message.

The server 140 includes a processor 142 coupled to a memory 146, and communication circuitry 144. The communication circuitry 144 includes a transmitter and a receiver or a combination thereof (e.g., a transceiver). In a particular implementation, the communication circuitry 144 (or the processor 142) is configured to encrypt outgoing message(s) using a private key associated with the server 140 and to decrypt incoming message(s) using a public key of a device (e.g., the UAV 102 or the control device 120) that sent the incoming message(s). As will be explained further below, the outgoing and incoming messages may be transaction messages that include information associated with the UAV. Thus, in this implementation, communication between the UAV 102, the control device 120, and the server 140 are secure and trustworthy (e.g., authenticated).

The processor 142 is configured to execute instructions from the memory 146 to perform various operations. The instructions include route instructions 148 comprising computer program instructions for aggregating data from disparate data servers, virtualizing the data in a map, generating a cost model for paths traversed in the map, and autonomously selecting the optimal route for the UAV based on the cost model. For example, the route instructions 148 are configured to partition a map of a region into geographic cells, calculate a cost for each geographic cell, wherein the cost is a sum of a plurality of weighted factors, determine a plurality of flight paths for the UAV from a first location on the map to a second location on the map, wherein each flight path traverses a set of geographic cells, determine a cost for each flight path based on the total cost of the set of geographic cells traversed, and select, in dependence upon the total cost of each flight path, an optimal flight path from the plurality of flight paths. The route instructions 148 are further configured to obtain data from one or more data servers regarding one or more geographic cells, calculate, in dependence upon the received data, an updated cost for each geographic cell traversed by a current flight path, calculate a cost for each geographic cell traversed by at least one alternative flight path from the first location to the second location, determine that at least one alternative flight path has a total cost that is less than the total cost of the current flight path, and select a new optimal flight path from the at least one alternative flight paths. The route instructions 148 may also include instructions for storing the parameters of the selected optimal flight path as route information 110. For example, the route information may include waypoints marked by GPS coordinates, arrival times for waypoints, pilot assignments. The route instructions 148 may also include instructions receiving, by a server in a UAV transportation ecosystem, disinfection area data; accessing, by the server, UAV parameters for a type of UAV; determining, by the server in dependence upon the disinfection area data and the UAV parameters, a number of UAVs needed to complete a coordinated aerial disinfection of a disinfection area within a time limit; and partitioning, by the server, the disinfection area into a plurality of partitions, wherein the number of partitions is equal to the number of UAVs. The server 140 may be configured to transmit the route information 110, including disinfection route information, to the UAV 102.

The instructions may also include control instructions 150 that include instructions or code that cause the server 140 to generate control data to transmit to the UAV 102 to enable the server 140 to control one or more operations of the UAV 102 during a particular time period, as further described herein.

The memory 146 of the server 120 also includes a mission controller 145 configured for multi-objective mission execution. In a particular embodiment, the mission controller 145 includes computer program instructions that when executed by the processor 142 cause the processor 142 to carry out the operations of: detecting a mode change event associated with a UAV executing a mission in a first mission mode; determining based on the mode change event, a second mission mode for the UAV; and switching a current mission mode of the UAV from the first mission mode to the second mission mode. In a particular embodiment, the mission controller 145 includes computer program instructions that when executed by the processor 142 cause the processor 142 to carry out the operations of: determining a plurality of mission modes for a UAV to perform during execution of a mission; generating at least one flight path linking a first mission mode of the plurality of mission modes to a second mission mode of the plurality of mission modes; and generating multi-objective mission route information including the at least one flight path and the plurality of mission modes of the UAV.

In the example of FIG. 1, the UAV 102, the control device 120, and the server 140, each include a mission controller (113, 139, 145). However, readers of skill in the art will realize that the mission controller may be included in any combination of the UAV 102, the control device 120, and the server 140. For example, in a particular embodiment, the mission controller is only included in the UAV 102. As another example, the mission controller may only be included in the control device 120.

In the example of FIG. 1, the memory 146 of the server 140 also includes communication instructions 147 that when executed by the processor 142 cause the processor 142 to transmit to the distributed computing network 151, transaction messages that include control instructions 150 that are directed to the UAV 102.

The distributed computing network 151 of FIG. 1 includes a plurality of computers 157. An example computer 158 of the plurality of computers 157 is shown and includes a processor 152 coupled to a memory 154, and communication circuitry 153. The communication circuitry 153 includes a transmitter and a receiver or a combination thereof (e.g., a transceiver). In a particular implementation, the communication circuitry 153 (or the processor 152) is configured to encrypt outgoing message(s) using a private key associated with the computer 158 and to decrypt incoming message(s) using a public key of a device (e.g., the UAV 102, the control device 120, or the server 140) that sent the incoming message(s). As will be explained further below, the outgoing and incoming messages may be transaction messages that include information associated with the UAV. Thus, in this implementation, communication between the UAV 102, the control device 120, the server 140, and the distributed computing network 151 are secure and trustworthy (e.g., authenticated).

The processor 145 is configured to execute instructions from the memory 154 to perform various operations. The memory 154 includes a blockchain manager 155 that includes computer program instructions for operating an UAV. Specifically, the blockchain manager 155 includes computer program instructions that when executed by the processor 152 cause the processor 152 to receive a transaction message associated with a UAV. For example, the blockchain manager may receive transaction messages from the UAV 102, the control device 120, or the server 140. The blockchain manager 155 also includes computer program instructions that when executed by the processor 152 cause the processor 152 to use the information within the transaction message to create a block of data; and store the created block of data in a blockchain data structure 156 associated with the UAV.

The blockchain manager may also include instructions for accessing information regarding an unmanned aerial vehicle (UAV). For example, the blockchain manager 155 also includes computer program instructions that when executed by the processor 152 cause the processor to receive from a device, a request for information regarding the UAV; in response to receiving the request, retrieve from a blockchain data structure associated with the UAV, data associated with the information requested; and based on the retrieved data, respond to the device.

The UAV 102, the control device 120, and server 140 are communicatively coupled via a network 118. For example, the network 118 may include a satellite network or another type of network that enables wireless communication between the UAV 102, the control device 120, the server 140, and the distributed computing network 151. In an alternative implementation, the control device 120 and the server 140 communicate with the UAV 102 via separate networks (e.g., separate short range networks).

In some situations, minimal (or no) manual control of the UAV 102 may be performed, and the UAV 102 may travel from the origin to the destination without incident. However, in some situations, one or more pilots may control the UAV 102 during a time period, such as to perform object avoidance or to compensate for an improper UAV operation. In some situations, the UAV 102 may be temporarily stopped, such as during an emergency condition, for recharging, for refueling, to avoid adverse weather conditions, responsive to one or more status indicators from the UAV 102, etc. In some implementations, due to the unscheduled stop, the route information 110 may be updated (e.g., via a subsequent blockchain entry, as further described herein) by route instructions 148 executing on the UAV 102, the control device 120, or the server 140). The updated route information may include updated waypoints, updated time periods, and updated pilot assignments.

In a particular implementation, the route information is exchanged using a blockchain data structure. The blockchain data structure may be shared in a distributed manner across a plurality of devices of the system 100, such as the UAV 102, the control device 120, the server 140, and any other control devices or UAVs in the system 100. In a particular implementation, each of the devices of the system 100 stores an instance of the blockchain data structure in a local memory of the respective device. In other implementations, each of the devices of the system 100 stores a portion of the shared blockchain data structure and each portion is replicated across multiple of the devices of the system 100 in a manner that maintains security of the shared blockchain data structure as a public (i.e., available to other devices) and incorruptible (or tamper evident) ledger. Alternatively, as in FIG. 1, the blockchain 156 is stored in a distributed manner in the distributed computing network 151.

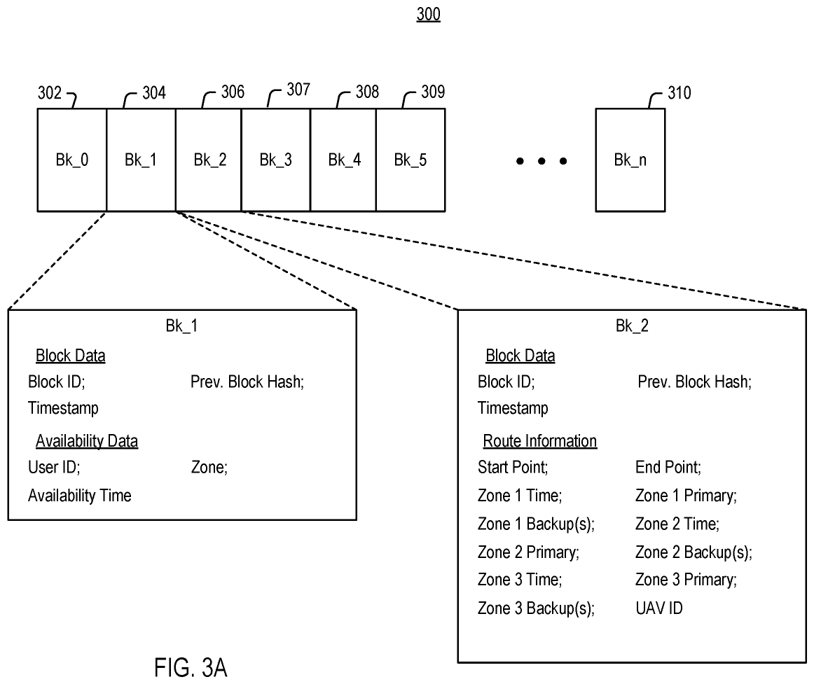

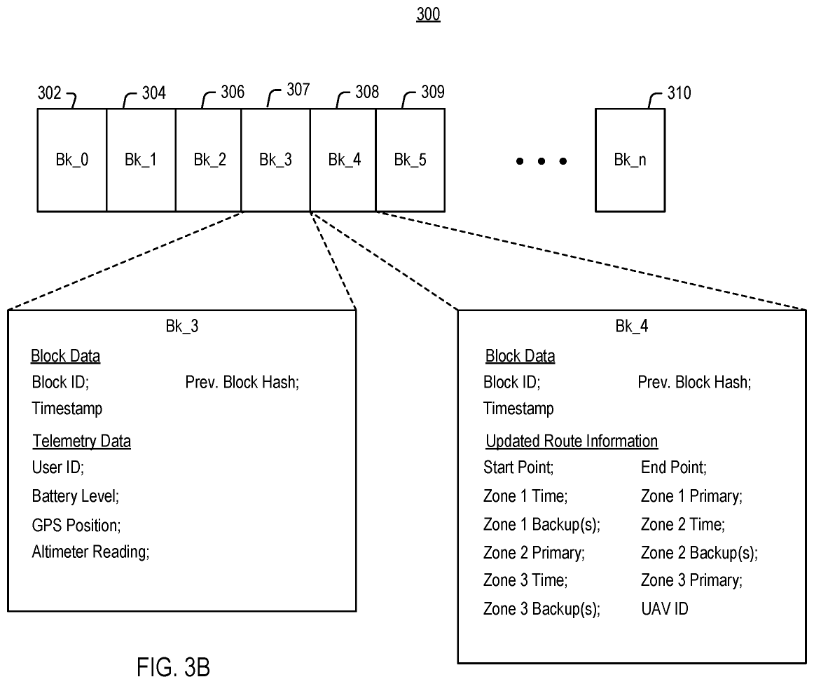

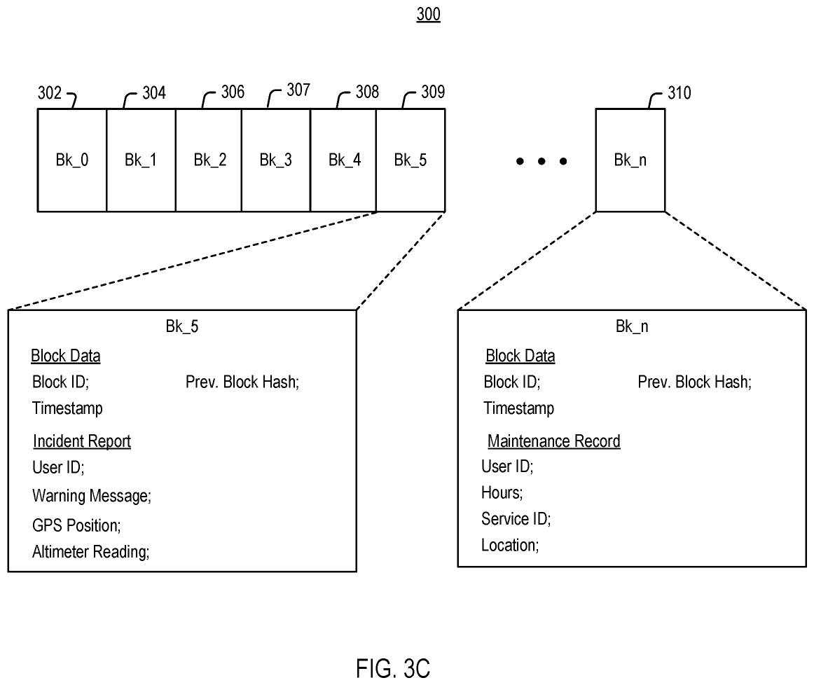

The blockchain data structure 156 may include, among other things, route information associated with the UAV 102, the telemetry data 107, the control instructions 131, and the route instructions 148. For example, the route information 110 may be used to generate blocks of the blockchain data structure 156. A sample blockchain data structure 300 is illustrated in FIGS. 3A-3C. Each block of the blockchain data structure 300 includes block data and other data, such as availability data, route data, telemetry data, service information, incident reports, etc.

The block data of each block includes information that identifies the block (e.g., a block ID) and enables the devices of the system 100) to confirm the integrity of the blockchain data structure 300. For example, the block data also includes a timestamp and a previous block hash. The timestamp indicates a time that the block was created. The block ID may include or correspond to a result of a hash function (e.g., a SHA256 hash function, a RIPEMD hash function, etc.) based on the other information (e.g., the availability data or the route data) in the block and the previous block hash (e.g., the block ID of the previous block). For example, in FIG. 3A, the blockchain data structure 300 includes an initial block (Bk_0) 302 and several subsequent blocks, including a block Bk_1 304, a block Bk_2 306, a block BK_3 307, a block BK_4 308, a block BK_5 309, and a block Bk_n 310. The initial block Bk_0 302 includes an initial set of availability data or route data, a timestamp, and a hash value (e.g., a block ID) based on the initial set of availability data or route data. As shown in FIG. 1, the block Bk_1 304 also may include a hash value based on the other data of the block Bk_1 304 and the previous hash value from the initial block Bk_0 302. Similarly, the block Bk_2 306 other data and a hash value based on the other data of the block Bk_2 306 and the previous hash value from the block Bk_1 304. The block Bk_n 310 includes other data and a hash value based on the other data of the block Bk_n 310 and the hash value from the immediately prior block (e.g., a block Bk_n−1). This chained arrangement of hash values enables each block to be validated with respect to the entire blockchain; thus, tampering with or modifying values in any block of the blockchain is evident by calculating and verifying the hash value of the final block in the block chain. Accordingly, the blockchain acts as a tamper-evident public ledger of availability data and route data for the system 100.

In addition to the block data, each block of the blockchain data structure 300 includes some information associated with a UAV (e.g., availability data, route information, telemetry data, incident reports, updated route information, maintenance records, etc.). For example, the block Bk_1 304 includes availability data that includes a user ID (e.g., an identifier of the mobile device, or the pilot, that generated the availability data), a zone (e.g., a zone at which the pilot will be available), and an availability time (e.g., a time period the pilot is available at the zone to pilot a UAV). As another example, the block Bk_2 306 includes route information that includes a UAV ID, a start point, an end point, waypoints, GPS coordinates, zone markings, time periods, primary pilot assignments, and backup pilot assignments for each zone associated with the route.

In the example of FIG. 3B, the block BK_3 307 includes telemetry data, such as a user ID (e.g., an identifier of the UAV that generated the telemetry data), a battery level of the UAV; a GPS position of the UAV; and an altimeter reading. As explained in FIG. 1, a UAV may include many types of information within the telemetry data that is transmitted to the blockchain managers of the computers within the distributed computing network 151. In a particular embodiment, the UAV is configured to periodically broadcast to the network 118, a transaction message that includes the UAV's current telemetry data. The blockchain managers of the distributed computing network receive the transaction message containing the telemetry data and store the telemetry data within the blockchain 156.

FIG. 3B also depicts the block BK_4 308 as including updated route information having a start point, an endpoint, and a plurality of zone times and backups, along with a UAV ID. In a particular embodiment, the control device 120 or the server 140 may determine that the route of the UAV should be changed. For example, the control device or the server may detect that the route of the UAV conflicts with a route of another UAV or a developing weather pattern. As another example, the control device or the server many determine that the priority level or concerns of the user have changed and thus the route needs to be changed. In such instances, the control device or the server may transmit to the UAV, updated route information, control data, or navigation information. Transmitting the updated route information, control data, or navigation information to the UAV may include broadcasting a transaction message that includes the updated route information, control data, or navigation information to the network 118. The blockchain manager 155 in the distributed computing network 151, retrieves the transaction message from the network 118 and stores the information within the transaction message in the blockchain 156.

FIG. 3C depicts the block BK_5 309 as including data describing an incident report. In the example of FIG. 3C, the incident report includes a user ID; a warning message; a GPS position; and an altimeter reading. In a particular embodiment, a UAV may transmit a transaction message that includes an incident report in response to the UAV experiencing an incident. For example, if during a flight mission, one of the UAV's propellers failed, a warning message describing the problem may be generated and transmitted as a transaction message.

FIG. 3C also depicts the block BK_n 310 that includes a maintenance record having a user ID of the service provider that serviced the UAV; flight hours that the UAV had flown when the service was performed; the service ID that indicates the type of service that was performed; and the location that the service was performed. UAV must be serviced periodically. When the UAV is serviced, the service provider may broadcast to the blockchain managers in the distributed computing network, a transaction message that includes service information, such as a maintenance record. Blockchain managers may receive the messages that include the maintenance record and store the information in the blockchain data structure. By storing the maintenance record in the blockchain data structure, a digital and immutable record or logbook of the UAV may be created. This type of record or logbook may be particularly useful to a regulatory agency and an owner/operator of the UAV.

Referring back to FIG. 1, in a particular embodiment, the server 140 includes software that is configured to receive telemetry information from an airborne UAV and track the UAV's progress and status. The server 140 is also configured to transmit in-flight commands to the UAV. Operation of the control device and the server may be carried out by some combination of a human operator and autonomous software (e.g., artificial intelligence (AI) software that is able to perform some or all of the operational functions of a typical human operator pilot).

In a particular embodiment, the route instructions 148 cause the server 140 to plan a flight path, generate route information, dynamically reroute the flight path and update the route information based on data aggregated from a plurality of data servers. For example, the server 140 may receive air traffic data 167 over the network 119 from the air traffic data server 160, weather data 177 from the weather data server 170, regulatory data 187 from the regulatory data server 180, and topographical data 197 from the topographic data server 190. It will be recognized by those of skill in the art that other data servers useful in-flight path planning of a UAV may also provide data to the server 140 over the network 101 or through direct communication with the server 140.

The air traffic data server 160 may include a processor 162, memory 164, and communication circuitry 168. The memory 164 of the air traffic data server 160 may include operating instructions 166 that when executed by the processor 162 cause the processor to provide the air traffic data 167 about the flight paths of other aircraft in a region, including those of other UAVs. The air traffic data may also include real-time radar data indicating the positions of other aircraft, including other UAVs, in the immediate vicinity or in the flight path of a particular UAV. Air traffic data servers may be, for example, radar stations, airport air traffic control systems, the FAA, UAV control systems, and so on.

The weather data server 170 may include a processor 172, memory 174, and communication circuitry 178. The memory 174 of the weather data server 170 may include operating instructions 176 that when executed by the processor 172 cause the processor to provide the weather data 177 that indicates information about atmospheric conditions along the UAV's flight path, such as temperature, wind, precipitation, lightening, humidity, atmospheric pressure, and so on. Weather data servers may be, for example, the National Weather Service (NWS), the National Oceanic and Atmospheric Administration (NOAA), local meteorologists, radar stations, other aircraft, and so on.

The regulatory data server 180 may include a processor 182, memory 184, and communication circuitry 188. The memory 184 of the weather data server 180 may include operating instructions 186 that when executed by the processor 182 cause the processor to provide the regulatory data 187 that indicates information about laws and regulations governing a particular region of airspace, such as airspace restrictions, municipal and state laws and regulations, permanent and temporary no-fly zones, and so on. Regulatory data servers may include, for example, the FAA, state and local governments, the Department of Defense, and so on.

The topographical data server 190 may include a processor 192, memory 194, and communication circuitry 198. The memory 194 of the topographical data server 190 may include operating instructions 196 that when executed by the processor 192 cause the processor to provide the topographical data that indicates information about terrain, places, structures, transportation, boundaries, hydrography, orthoimagery, land cover, elevation, and so on. Topographic data may be embodied in, for example, digital elevation model data, digital line graphs, and digital raster graphics. Topographic data servers may include, for example, the United States Geological Survey or other geographic information systems (GISs).

In some embodiments, the server 140 may aggregate data from the data servers 160, 170, 180, 190 using application program interfaces (APIs), syndicated feeds and eXtensible Markup Language (XML), natural language processing, JavaScript Object Notation (JSON) servers, or combinations thereof. Updated data may be pushed to the server 140 or may be pulled on-demand by the server 140. Notably, the FAA may be an important data server for both airspace data concerning flight paths and congestion as well as an important data server for regulatory data such as permanent and temporary airspace restrictions. For example, the FAA provides the Aeronautical Data Delivery Service (ADDS), the Aeronautical Product Release API (APRA), System Wide Information Management (SWIM), Special Use Airspace information, and Temporary Flight Restrictions (TFR) information, among other data. The National Weather Service (NWS) API allows access to forecasts, alerts, and observations, along with other weather data. The USGS Seamless Server provides geospatial data layers regarding places, structures, transportation, boundaries, hydrography, orthoimagery, land cover, and elevation. Readers of skill in the art will appreciate that various governmental and non-governmental entities may act as data servers and provide access to that data using APIs, JSON, XML, and other data formats.

Readers of skill in the art will realize that the server 140 can communicate with a UAV 102 using a variety of methods. For example, the UAV 102 may transmit and receive data using Cellular, 5G, Sub1 GHz, SigFox, WiFi networks, or any other communication means that would occur to one of skill in the art.

The network 119 may comprise one or more Local Area Networks (LANs), Wide Area Networks (WANs), cellular networks, satellite networks, internets, intranets, or other networks and combinations thereof. The network 119 may comprise one or more wired connections, wireless connections, or combinations thereof.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), and others as will occur to those of skill in the art. Various embodiments of the present invention may be implemented on a variety of hardware platforms in addition to those illustrated in FIG. 1.

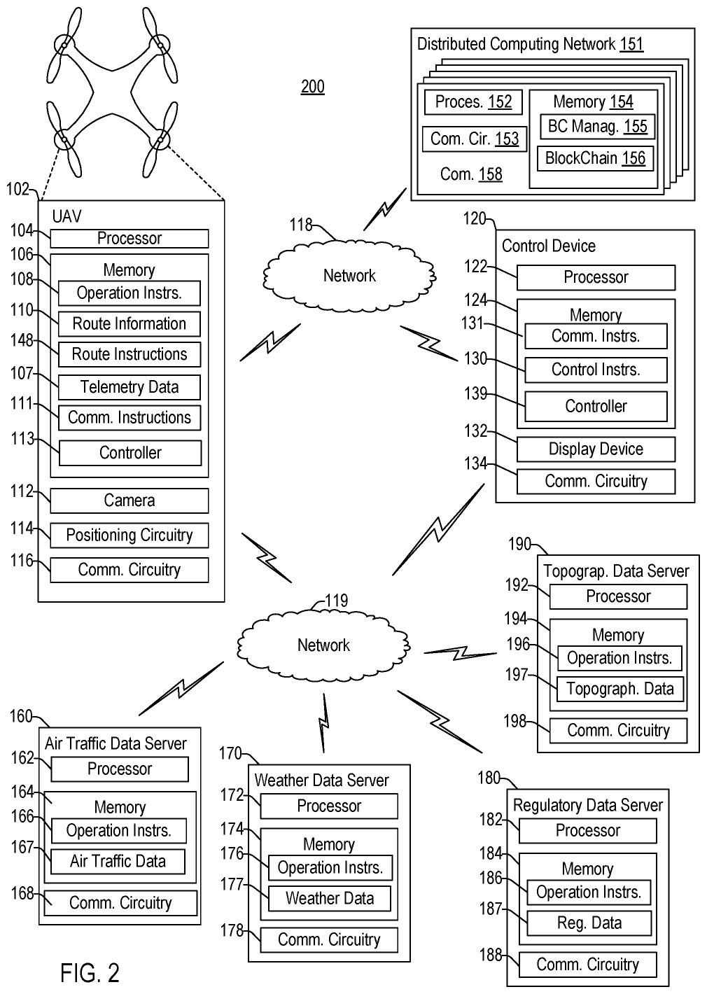

For further explanation, FIG. 2 sets forth a block diagram illustrating another implementation of a system 200 for operating a UAV. Specifically, the system 200 of FIG. 2 shows an alternative configuration in which one or both of the UAV 102 and the server 140 may include route instructions 148 for generating route information. In this example, instead of relying on a server 140 to generate the route information, the UAV 102 and the control device 120 may retrieve and aggregate the information from the various data sources (e.g., the air traffic data server 160, the weather data server 170, the regulatory data server 180, and the topographical data server 190). As explained in FIG. 1, the route instructions may be configured to use the aggregated information from the various source to plan and select a flight path for the UAV 102.

A UAV, such as the UAV 102 of FIGS. 1 and 2, may be used to perform mission modes. A mission mode, as set forth herein, is defined as an intended purpose for which the UAV is being flown. In some examples, a mission mode may be strictly controlled, so that the UAV flies a particular, controlled route. For example, a waypoint mission mode follows a set of waypoints. In another example, a mission mode may include surveillance in which the UAV flies a particular pattern to observe a location. In another example, a mission mode may be loosely defined with a start time, stop time, and/or general location. For example, a mission mode may be free flight mission mode, in which there is no pattern to follow. Instead, an operator may fly the UAV during free flight using remote controls. In some examples, the mission mode may lie in between strictly controlled and loosely defined. For example, a mission mode may be a waypoint mission mode, in which the UAV should pass defined waypoints, but may be free to plot its course between the waypoints.

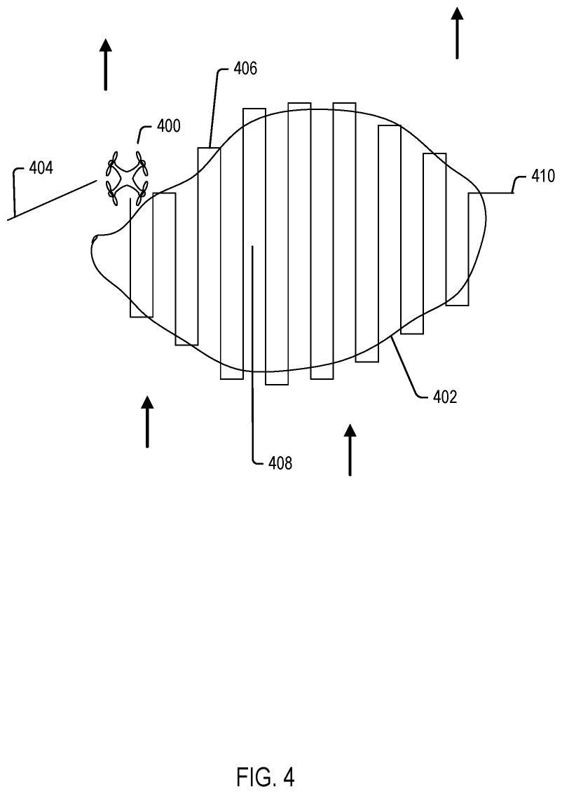

For further explanation, FIG. 4 sets forth a diagram illustrating one example of a strictly defined mission mode for a UAV 400 in the form of a surveillance mission mode. In the example of FIG. 4, the mission objection is to surveil a geographic feature, in the form of lake 402. The UAV 400 may surveil the lake 402 to look for a particular object such as boat 408, or in other example the UAV 400 may surveil the lake 402 to record an overhead view of the lake 402. In either case, the UAV may start at a fixed origin 404 and follow a defined flight path 406 calculated to ensure that the UAV 400 flies over the entirety of the lake 402. After surveilling the lake 402, the UAV may return to the origin 404 or, in some examples, the UAV may fly to a destination 410. The defined flight path 406 may comprise a sweeping pattern, in which the UAV sweeps adjoining segments in alternating directions.

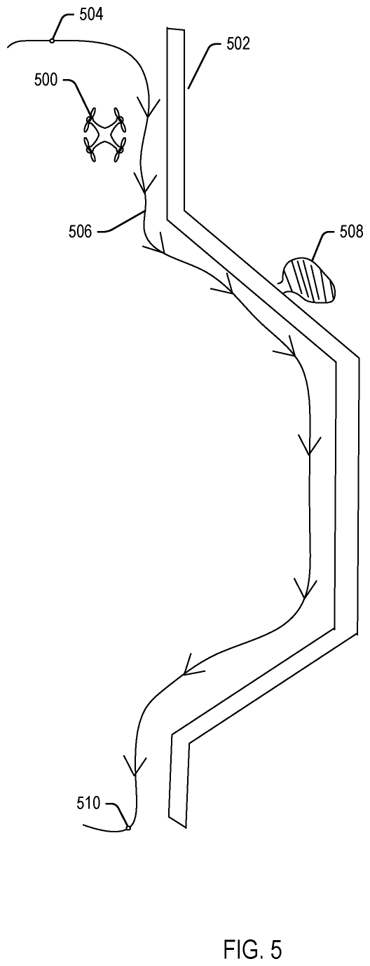

For further explanation, FIG. 5 sets forth a diagram illustrating another example of a strictly defined mission mode for a UAV 500 in the form of a surveillance mission mode. In this example, the mission mode is to surveil a longitudinal object, such as a pipeline 502 or a canal. An origin 504 defines where the UAV 500 should start the surveillance mission mode and a destination 510 defines where the UAV 500 should end the surveillance mission mode. A linear flight path 506 is calculated to extend along the longitudinal object to enable the UAV 500 to view a selected portion of the longitudinal object. The UAV 500 may be configured to detect any abnormalities along the linear flight path 506, such as a spill 508. In some examples, the origin 504 and the destination 510 may coincide with one another. For example, the linear flight path 506 may reverse and extend back to the origin such that the longitudinal object can be surveilled in two passes.

In the preceding examples of FIGS. 4 and 5, the origin 404, 504 and the destination 410, 510 can be geographical locations such as GPS waypoints. The origin 404, 504 and the destination 410, 510 can have associated time components such that the UAV 400, 500 should not begin or end the surveillance objective until a predetermined time. The flight path 406, 506 can include speed information for the UAV 400, 500, such that the time required to traverse the flight path 406, 506 can be set by adjusting the speed information. Thus, if the UAV 400, 500 is at the origin 404, 504 at the predetermined time, the time at which it will reach the destination 410, 510 can be determined. The UAV 400, 500 may adjust its speed as necessary to reach the destination 410, 510 at the predetermined time. For example, if the UAV 400, 500 is late or early arriving at the origin 404, 504, the UAV 400, 500 may recalculate the speed required to reach the destination 410, 510 at the predetermined time. Thus, if the UAV 400, 500 arrives late to the origin 404, 504, the UAV 400, 500 may increase its speed along the flight path 406, 506, or if the UAV 400, 500 arrives early to the origin 404, 504, the UAV 400, 500 may decrease its speed along the flight path 406, 506.

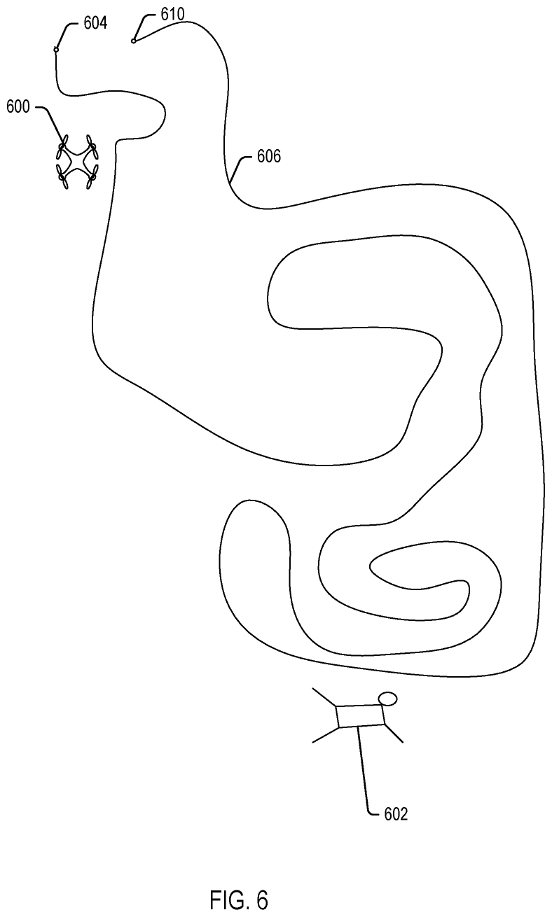

For further explanation, FIG. 6 sets forth a diagram illustrating an example of a loosely defined mission mode in the form of a free flight mission mode. In this example, the mission mode is to perform a free flight by an operator. The free flight mission mode may include an origin 604 and a destination 610 for starting and ending the free flight mission mode. The origin 604 and the destination 610 may have associated time components. The operator may freely fly the UAV 600 in a path 606 that is not pre-determined and thus the operator may be free to inspect any object of interest that they may find, such as a wild animal 602. In some examples, the UAV 600 may calculate the time required to reach the destination 610 from the UAV's current location and take over control of the UAV 600 to ensure that the UAV 600 reaches the destination 610 at a predetermined time. Or, in other examples, the operator may be warned that it is time to head to the destination 610. For example, while performing free flight to observe wild animal 608, the UAV 600 may calculate that the UAV 600 needs to begin to head to the destination in order to leave at the predetermined time. The UAV 600 may take control, ask the operator for control, or warn the operator to head to the destination 610.

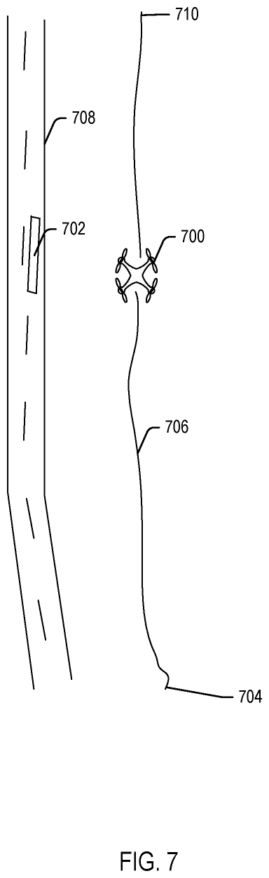

For further explanation, FIG. 7 sets forth a diagram illustrating an example of a mission mode in the form of a follow mission mode. In this example, the mission mode is to follow an object, such as a truck 702 along a highway 708. The follow mission mode may include an origin 704 and a destination 710 for starting and exiting the mission mode. As in the previous examples, the origin 704 and the destination 710 may have associated time components. The follow mission mode may include portions of a free flight or a surveillance mission. For example, the follow mission mode may start as free flight until an operator recognizes an object to follow, at which point the UAV 700 may fly on a flight path 706 that follows the object. Or in another example, the follow mission mode may begin with a surveillance mission mode as described in relation to FIGS. 4 and 5, and switch to a follow mission mode if a particular object is detected during the surveillance mission mode.

As described with regard to FIG. 7, mission modes can be nested within one another such that a first mission mode may be converted to a second mission mode if a particular event occurs, such as detecting an object. If a first mission mode is converted to a second mission mode, the second mission mode exit at the first mission modes destination. For example, if a surveillance mission is converted to a follow mission mode, the follow mission mode may keep the destination of the original surveillance mission mode. Thus, when the second mission mode is completed, the UAV may return to the known destination of the first mission mode.

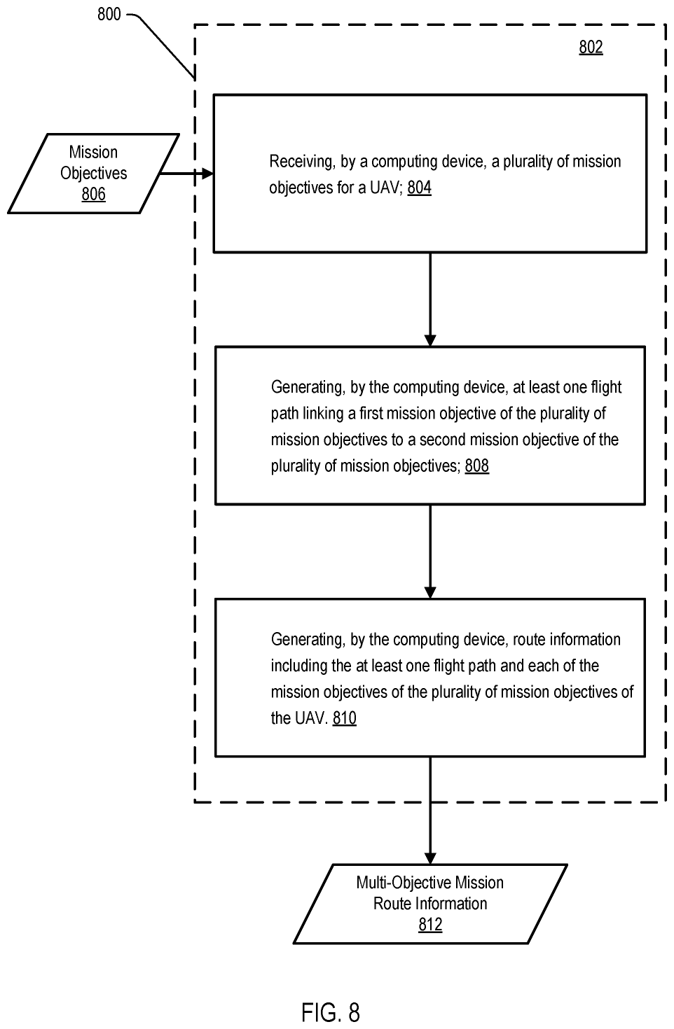

For further explanation, FIG. 8 sets forth a flow chart illustrating an exemplary method 900 for multi-objective mission planning and execution for a UAV in accordance with at least one embodiment of the present disclosure. The method of FIG. 8 may be implemented by a computing device 802 that may provide multi-objective mission route information to a UAV for performing a multi-objective mission. The computing device 1001 may be a UAV (e.g., the UAV 102 of FIGS. 1 and 2, the control device 120 of FIGS. 1 and 2, the server 140 of FIG. 1).

For example, in some embodiments the computing device 802 of FIG. 8 can be the control device 120 of FIGS. 1 and 2, the server 140 of FIGS. 1 and 2, or the distributed computing network 151 of FIGS. 1 and 2. In this example, the UAV can be the UAV 102 of FIGS. 1 and 2 and the mission modes can be, but are not limited to those described in relation to FIGS. 4-7.

The computing device 802 can be a computing device that is local to a user, such as control device 120 of FIG. 1, a computing device that is local to a UAV, such as UAV 102 of FIG. 1, or a device that is remote to both the user and the UAV, such as a server 140.

The method 800 begins with receiving 804, by the computing device 802, a plurality of mission modes 806 for a UAV to perform. The plurality of mission modes 806 can be any form of data that represents the plurality of mission modes 806. Each mission mode of the plurality of mission modes 806 can be, but is not limited to, any of the previously described mission modes. Each mission mode may include information describing the mission mode, such as waypoints, waypoint times, object types, and mission mode priorities. For example, a surveillance mission mode may include information describing an origin, a destination, a location of the object to be surveilled, a shape of the object to be surveilled, and a path width. In another example, a free flight mission mode may include an origin, a destination, and/or a flight time. In yet another example, a waypoint mission mode may include a plurality of waypoints to follow. In still another example, a follow mission mode may include information describing an object to follow.

Waypoints may include the origin and destination along with any time component for each mission mode and any waypoints within the mission mode. An object type may include an object to surveil, an object to follow, or an object to recognize. Additionally, the object type may include further information such as the size, shape, and location of the object such that a mission mode flight plan may be calculated to accomplish the mission mode. The mission mode priority can be a priority for accomplishing each mission mode compared to the other mission modes of a mission. For example, a free flight mission mode may be set to have a low priority such that a UAV will end the free flight mission mode on time to ensure that the next mission mode is started on time. Or, in another example, a free flight mission mode may have a high priority such that the next mission mode may be allowed to start later if necessary.

In examples in which the computing device 802 is local to a user, the computing device 802 may receive the plurality of mission modes 806 by way of user interaction with a user interface of the computing device 802. For example, the user interface of the computing device 802 may prompt a user to enter a mission mode along with any additional information.

In examples in which the computing device 802 is local to the UAV 102, the plurality of mission modes 806 may be received by the computing device 802 by way of a communication link, such as network 118 of FIG. 1. With reference to FIG. 1, the computing device 802 of the UAV 102 may include communication circuitry 116 communicating with a control device 120 by way of communication circuitry 116 and communication circuitry 134. The control device 120 can send the mission modes 806 by way of network 118. The computing device 802 of the UAV 102 then receives the mission modes 806 by way of the network 118.

In examples in which the computing device 802 is remote to both a user and the UAV 102, a remote computing device such as a server 140 of FIG. 1 may receive the plurality of mission modes 806 by way of network 118. For example, the server 140 may receive the plurality of mission modes 806 from the control device 120 over network 118. In some examples, the method 800 may be implemented by a server 140 as part of a service provided to UAV users. For example, server 140 may cause a local computing device to display a user interface for interacting with a user. The user may input information identifying the plurality of mission modes 806 by way of the user interface.

In examples in which the computing device 802 is remote to both a user and the UAV 102, a remote computing device such as a server 140 of FIG. 1 may receive the plurality of mission modes 806 by way of network 118. For example, the server 140 may receive plurality of mission modes 806 from the control device 120 over network 118. In some examples, the method 800 may be implemented by a server 140 as part of a service provided to UAV users. For examples, server 140 may cause a local computing device to display a user interface for interacting with a user. The user may input information identifying the mission modes by way of the user interface.

The computing device 802 then generates 808 at least one flight path linking a first mission mode of the plurality of mission mode 806 to a second mission mode of the plurality of mission modes 806. For example, the computing device 802 may generate a first flight path that links a start point for the multi-objective mission to an entry point for a first mission mode, a second flight path linking an exit point for the first mission objection to an entry point of a second mission mode, and so forth for each mission mode of the plurality of mission modes. The computing device 802 may further generate a final light path linking an exit point of a final mission mode to an end point of the multi-objective mission. Each of the flight paths may comprise a series of waypoint for the UAV 102 to follow between the mission modes. In some examples, each of the flight paths can further include time components for at least one waypoint to assist the UAV 102 in completing each mission mode at a predetermined time. In a particular embodiment, the flight paths are linked with only time components such that each mission mode is executed for a particular amount of time or at particular start/end times without being limited by starting and ending waypoints. The at least one flight path may be generated to route the UAV based on available data such as airspace information, weather patterns, geographic information, and other data. For example, the flight path may be generated to avoid potential hazards, such as restricted airspace, weather disturbances, and/or uneven terrain.

Once the computing device 802 has received the plurality of mission modes 806 and the at least one flight path linking each of the plurality of mission modes 806, the computing device 802 may generate 810 multi-objective mission route information 812 for the UAV 102. The multi-objective mission route information 812 combines the at least one flight path and the plurality of mission modes 806 into a single mission for the UAV 102 to perform. In some examples, the multi-objective mission route information 812 can comprise a series of waypoints in chronological order for the UAV 102 to follow. For example, the waypoints can indicate where the UAV 102 should be at specific times. A gap in time in the waypoints may indicate that the UAV 102 is entering a free flight mission mode. In other examples, the multi-objective mission route information 812 can comprise the waypoints for each flight path between the mission modes and data describing each of the mission modes. In such examples, the UAV 102 may interpret the data describing the mission modes and generate its own route as required either before or during performance of the mission mode. For example, if the UAV 102 is performing a follow mission mode, the flight waypoints necessary to follow an object would not be known ahead of time and the UAV 102 may be responsible for performing the follow mission mode without following any waypoints.

In examples in which the computing device 802 is the control device 120 or the server 140 of FIGS. 1 and 2, the multi-objective mission route information 812 generated by the computing device 802 may be sent directly to the UAV 102, or the multi-objective mission route information 812 may be stored for later use. In examples in which the computing device 802 is onboard the UAV 102, the UAV 102 may implement the multi-objective mission immediately, or the UAV 102 may store the multi-objective mission route information 812 to perform the multi-objective mission at a later time.

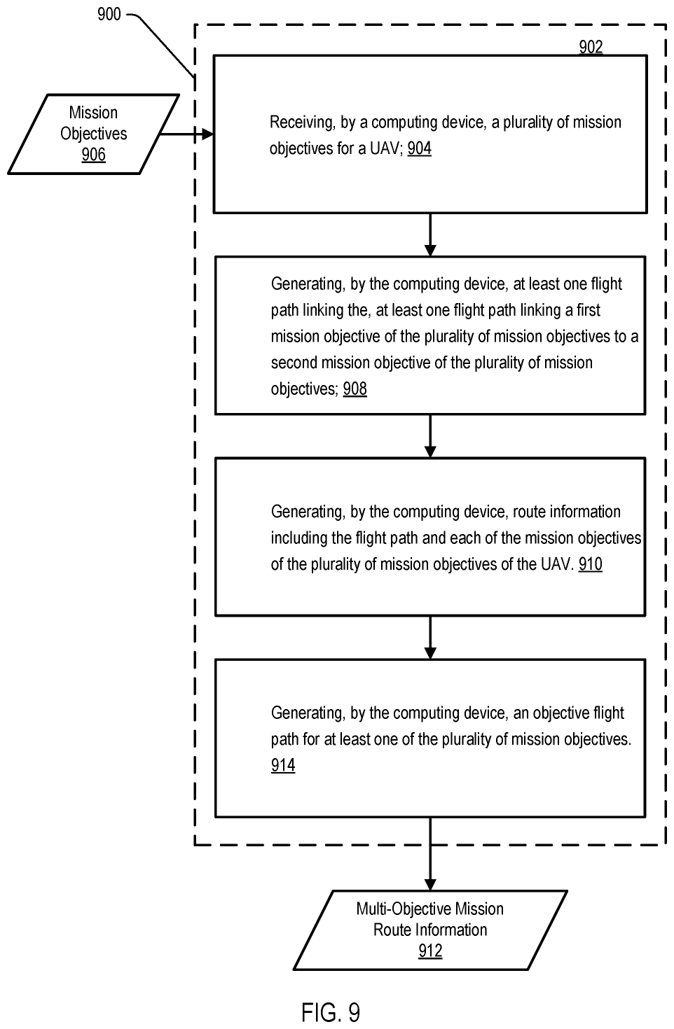

For further explanation, FIG. 9 sets forth a flow chart illustrating an exemplary method 900 for multi-objective mission planning and execution for a UAV in accordance with at least one embodiment of the present disclosure. The method of FIG. 9 is similar to the method of FIG. 8 and may be implemented by a computing device 902 to provide multi-objective mission route information to a UAV for performing a multi-objective mission. Like the example of FIG. 8, in some embodiments the computing device 902 of FIG. 9 can be the control device 120 of FIGS. 1 and 2, the server 140 of FIGS. 1 and 2, or the distributed computing network 151 of FIGS. 1 and 2. The UAV can be the UAV 102 of FIGS. 1 and 2 and the mission modes can be, but are not limited to those described in relation to FIGS. 4-7.

The exemplary method 900 includes the steps of receiving 904 a plurality of mission modes 906 for a UAV to perform, generating 908 at least one flight path linking a first mission mode of the plurality of mission modes 906 to a second mission mode of the plurality of mission modes 906, and generating 910 multi-objective mission route information 912 including the at least one flight path and the plurality of mission modes 906 as described in relation to FIG. 8. The exemplary method 900 of FIG. 9 differs from that of FIG. 8 in that the exemplary method 900 of FIG. 9 further includes the computing device 902 generating 914 an objective flight path for at least one of the plurality of mission modes.

Generating 914 an objective flight path can comprise analyzing a mission mode and generating waypoints for the UAV to follow when performing the mission mode. For example, in a surveillance mission mode, the computing device 902 may calculate a sweeping pattern of way points for the UAV to follow in order to cover an entirety of an object.

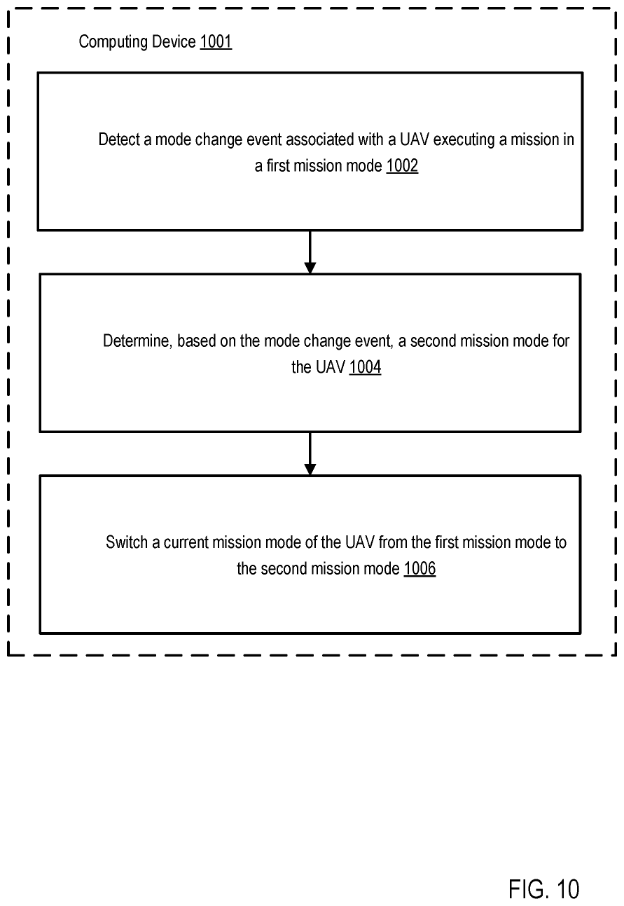

For further explanation, FIG. 10 sets forth a flow chart illustrating an exemplary method for multi-objective mission planning and execution for a UAV in accordance with at least one embodiment of the present disclosure. In the example of FIG. 10, the computing device 1001 may be a UAV (e.g., the UAV 102 of FIGS. 1 and 2, the control device 120 of FIGS. 1 and 2, the server 140 of FIG. 1).

The method of FIG. 10 includes detecting 1002, by a computing device 1001, a mode change event associated with a UAV executing a mission in a first mission mode. Each mission mode may be, but is not limited to, any of the previously described mission modes. Each mission mode may include information describing the mission mode, such as waypoints, waypoint times, object types, and mission mode priorities. For example, a surveillance mission mode may include information describing an origin, a destination, a location of the object to be surveilled, a shape of the object to be surveilled, and a path width. In another example, a free flight mission mode may include an origin, a destination, and/or a flight time. In yet another example, a waypoint mission mode may include a plurality of waypoints to follow. In still another example, a follow mission mode may include information describing an object to follow.

Waypoints may include the origin and destination along with any time component for each mission mode and any waypoints within the mission mode. An object type may include an object to surveil, an object to follow, or an object to recognize. Additionally, the object type may include further information such as the size, shape, and location of the object such that a mission mode flight plan may be calculated to accomplish the mission mode. The mission mode priority can be a priority for accomplishing each mission mode compared to the other mission modes of a mission. For example, a free flight mission mode may be set to have a low priority such that a UAV will end the free flight mission mode on time to ensure that the next mission mode is started on time. Or, in another example, a free flight mission mode may have a high priority such that the next mission mode may be allowed to start later if necessary.

A mode change event may specify a type of user input, a particular location of the UAV, a range of locations for the UAV to operate, object detection parameters (e.g., type of object), a sensor measurement (e.g., temperature, altitude, wind speed, smoke, proximity to another device, etc.) Detecting 1002, by a computing device 1001, a mode change event associated with a UAV executing a mission in a first mission mode may be carried out by detecting that a user has input a selection related to the mission mode; detecting that the UAV is within a proximity to a particular location; detecting that the UAV is operating within a particular range of locations (e.g., a first location at first GPS coordinates, a second location at second GPS coordinates); detecting that a predetermined object type has been detected in a proximity to the UAV; and detecting a sensor of the UAV is indicating a value that outside a particular threshold or range.

The method of FIG. 10 also includes determining 1004, based on the mode change event, by the computing device 1001, a second mission mode for the UAV. The computing device may include an index that matches a particular mode change event with a switch to a particular mission mode. For example, determining 1004, based on the mode change event, by the computing device 1001, a second mission mode for the UAV may be carried out by identifying a mission mode that matches the particular mode change event in the index. Alternatively, a user may provide input that requests the UAV switch from the first mission mode to the second mission mode. In this example, the user input may specify the second mission mode.

In addition, the method of FIG. 10 also includes switching 1006, by the computing device 1001, a current mission mode of the UAV from the first mission mode to the second mission mode. Switching 1006, by the computing device 1001, a current mission mode of the UAV from the first mission mode to the second mission mode may be carried out by instructing, by a computing device (e.g., a control device, such as control device 120 of FIG. 1), the UAV (e.g., UAV 102 of FIG. 1) to switch to the second mission mode. For example, a user may provide input to the control device to switch modes and the control device may instruct the UAV to switch modes (e.g., from waypoint mission mode to a surveillance mission mode; from a waypoint mission mode to a free flight mission mode; from a free flight mission mode to a waypoint mission mode; from a follow mission mode to a free flight mission mode, etc.). Alternatively, when the computing device is a UAV, switching 1006, by the computing device 1001, a current mission mode of the UAV from the first mission mode to the second mission mode may be carried out by the processor of the UAV making changes to processes with the UAV or storing values in memory that indicate the change in mission modes.

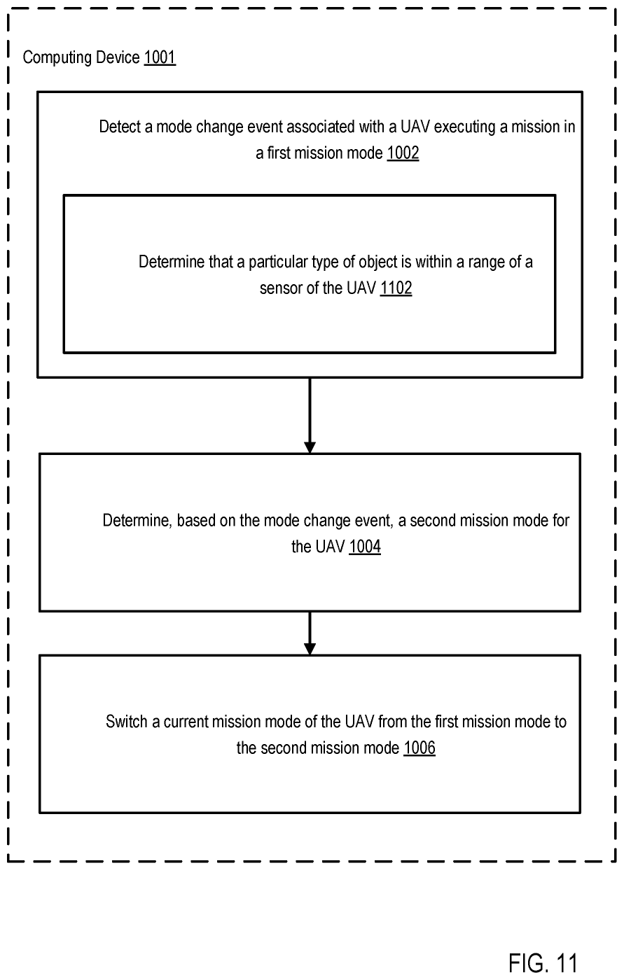

For further explanation, FIG. 11 sets forth a flow chart illustrating an exemplary method for multi-objective mission planning and execution for a UAV in accordance with at least one embodiment of the present disclosure. The method of FIG. 11 is similar to the method of FIG. 10 in that the method of FIG. 11 also includes detecting 1002, by a computing device 1001, a mode change event associated with a UAV executing a mission in a first mission mode; determining 1004, based on the mode change event, by the computing device 1001, a second mission mode for the UAV; and switching 1006, by the computing device 1001, a current mission mode of the UAV from the first mission mode to the second mission mode.

In the method of FIG. 11, detecting 1002, by a computing device 1001, a mode change event associated with a UAV executing a mission in a first mission mode includes determining 1102 that a particular type of object is within a range of a sensor of the UAV. Determining 1102 that a particular type of object is within a range of a sensor of the UAV may be carried out by receiving data generated by one or more sensors of a UAV; and determining based on the received data, a presence and an identification of an object in a proximity of the UAV. A proximity of a UAV may be a physical range of one or more sensors of the UAV. A presence of an object may be a positive indication of an object. An identification of an object may be an indication of a particular type of object; or a parameter/characteristic of an object. Determining based on the received data, a presence and an identification of an object in a proximity of the UAV may be carried out by receiving from a user, data that identifies the object or receiving from another computing device, data that identifies the object. Alternatively, the computing device may include object recognition and detection programs and processes that are capable of detecting and identifying an object without intervention from a user or another device. In this example, the recognition and detection programs and processes may search for specific parameters and characteristics within the sensor data; and determine that a match of the sensor data to particular parameters or characteristics represents a detection and an identification of a specific object.

The object for detection by the UAV can be any object that a user desires to be detected by the UAV. For example, the object can be a person, an animal, a vehicle, a structure, a liquid, a plant, smoke, or a fire. In some examples, the object can detect a general object type such as any person, animal, vehicle, structure, liquid, plant, smoke, or fire, or it can be a specific object limited to a particular set or individual item. For example, the object could be a particular person. In such instances, the object may be identified using techniques such as facial recognition or other identification techniques. In other examples, the object to be detected can be a set of persons, such as persons having a particular characteristic. For example, the object to be detected could be people wearing a certain color, people of a certain height, or people matching a certain description. In still other examples, the object to be detected can be limited to an object in a particular location or in association with another object. For example, a UAV inspecting a pipeline may not react to the detection of a liquid unless the liquid is adjacent to a pipeline, or a person may be ignored unless they are within a specific geographic boundary. In another example, a characteristic may include patterns for recognition such as a bar code or quick response (QR) code, an object temperature, a movement characteristic such as smooth or intermittent, a gait style, object emissions, sound patterns, or other characteristics. Determining the presence and the identification of a particular object may rely upon a plurality of sensors. For example, the sensor data may include information from a camera for a visual identification, a microphone for audio detection, a GPS system for identifying location, and/or a thermal sensor for identifying a temperature.

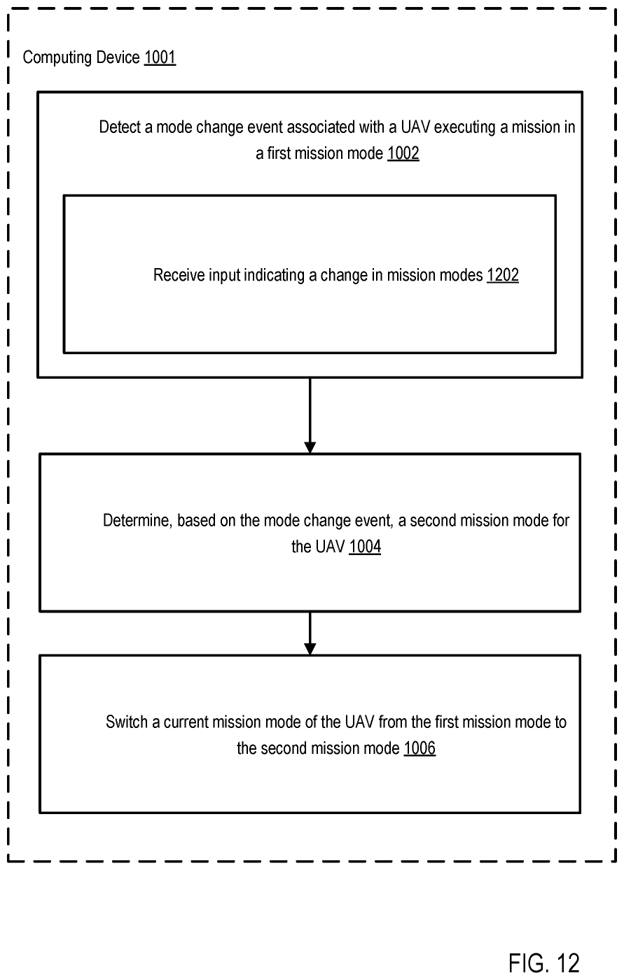

For further explanation, FIG. 12 sets forth a flow chart illustrating an exemplary method for multi-objective mission planning and execution for a UAV in accordance with at least one embodiment of the present disclosure. The method of FIG. 12 is similar to the method of FIG. 10 in that the method of FIG. 12 also includes detecting 1002, by a computing device 1001, a mode change event associated with a UAV executing a mission in a first mission mode; determining 1004, based on the mode change event, by the computing device 1001, a second mission mode for the UAV; and switching 1006, by the computing device 1001, a current mission mode of the UAV from the first mission mode to the second mission mode.

In the method of FIG. 12, detecting 1002, by a computing device 1001, a mode change event associated with a UAV executing a mission in a first mission mode includes receiving 1202 input indicating a change in mission modes. Receiving 1202 input indicating a change in mission modes may be carried out by receiving at a control device or at a remote control, input that indicates a change in the mission modes. For example, when the UAV is operating in a waypoint mission mode, if the user provides user input in the form of pushing the controls for the UAV, the UAV may switch to a free flight mission mode. As another example, when the UAV is operating in a free flight mission mode, if the user provides user input in the form of pushing a button on the remote control or activating a button in a graphical user interface, the UAV may switch to another mode (e.g., the waypoint mission mode; the surveillance mission mode; etc.).

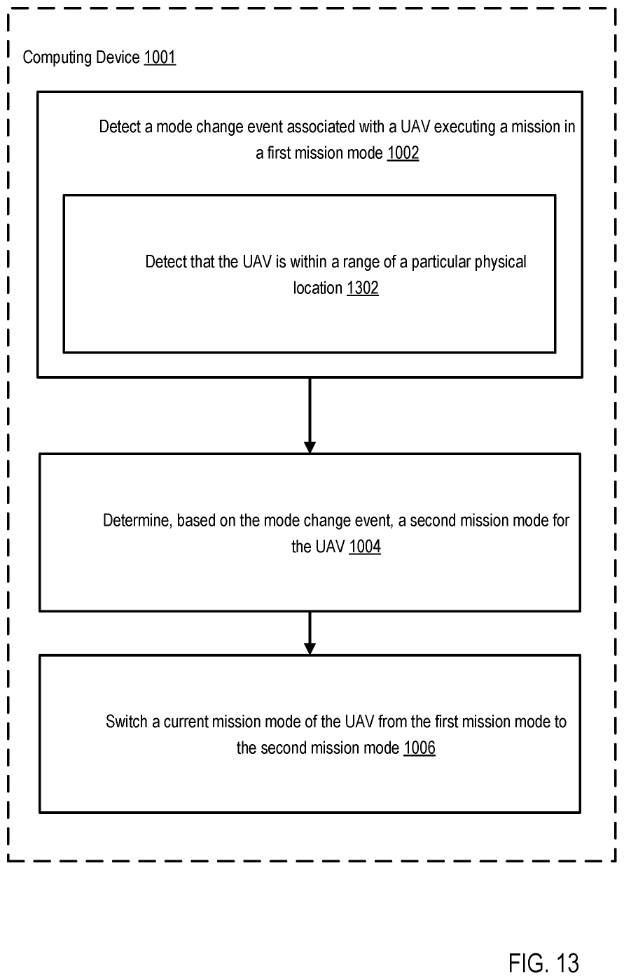

For further explanation, FIG. 13 sets forth a flow chart illustrating an exemplary method for multi-objective mission planning and execution for a UAV in accordance with at least one embodiment of the present disclosure. The method of FIG. 13 is similar to the method of FIG. 10 in that the method of FIG. 13 also includes detecting 1002, by a computing device 1001, a mode change event associated with a UAV executing a mission in a first mission mode; determining 1004, based on the mode change event, by the computing device 1001, a second mission mode for the UAV; and switching 1006, by the computing device 1001, a current mission mode of the UAV from the first mission mode to the second mission mode.

In the method of FIG. 13, detecting 1002, by a computing device 1001, a mode change event associated with a UAV executing a mission in a first mission mode includes detecting 1302 that the UAV is within a range of a particular physical location. Detecting 1302 that the UAV is within a range of a particular physical location may be carried out by using sensors on the UAV to determine if the UAV is within a range of a particular set of coordinates; using radar to determine the location of the UAV; using data from other UAVs, or devices to determine the location of the UAV.

Exemplary embodiments of the present invention are described largely in the context of a fully functional computer system for utilizing an unmanned aerial vehicle to perform an action in response to detection of an object. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Hardware logic, including programmable logic for use with a programmable logic device (PLD) implementing all or part of the functionality previously described herein, may be designed using traditional manual methods or may be designed, captured, simulated, or documented electronically using various tools, such as Computer Aided Design (CAD) programs, a hardware description language (e.g., VHDL or Verilog), or a PLD programming language. Hardware logic may also be generated by a non-transitory computer readable medium storing instructions that, when executed by a processor, manage parameters of a semiconductor component, a cell, a library of components, or a library of cells in electronic design automation (EDA) software to generate a manufacturable design for an integrated circuit. In implementation, the various components described herein might be implemented as discrete components or the functions and features described can be shared in part or in total among one or more components. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Advantages and features of the present disclosure can be further described by the following statements:

1. A method for multi-objective mission execution for an unmanned aerial vehicle (UAV), the method comprising: detecting, by a computing device, a mode change event associated with a UAV executing a mission in a first mission mode; determining based on the mode change event, by the computing device, a second mission mode for the UAV; and switching, by the computing device, a current mission mode of the UAV from the first mission mode to the second mission mode.

2. The method of statement 1, wherein detecting, by a computing device, a mode change event associated with a UAV executing a mission in a first mission mode includes: determining that a particular type of object is within a range of a sensor of the UAV.

3. The method of any of the statements 1-2, wherein detecting, by a computing device, a mode change event associated with a UAV executing a mission in a first mission mode includes: receiving input indicating a change in mission modes.

4. The method of any of the statements 1-3, wherein detecting, by a computing device, a mode change event associated with a UAV executing a mission in a first mission mode includes: detecting that the UAV is within a range of a particular physical location.

5. The method of any of the statements 1-4, wherein the plurality of mission modes includes at least one of a free flight mission mode, a waypoint mission mode, a surveillance mission mode, and a follow mission mode.

6. A method that includes none or any of the statements 1-5, the method comprising: determining, by a computing device, a plurality of mission modes for a UAV to perform during execution of a mission; generating, by the computing device, at least one flight path linking a first mission mode of the plurality of mission modes to a second mission mode of the plurality of mission modes; and generating, by the computing device, multi-objective mission route information including the at least one flight path and the plurality of mission modes of the UAV.

7. The method of any of the statements 1-6, further comprising, generating, by the computing device, an objective flight path for at least one of the plurality of mission modes.

8. The method of any of the statements 1-7, wherein the objective flight path comprises a sweeping pattern of waypoints.

9. The method of any of the statements 1-8, wherein the plurality of mission modes includes at least one of a free flight mission mode, a waypoint mission mode, a surveillance mission mode, and a follow mission mode.

10. The method of any of the statements 1-9, wherein at least one of the plurality of mission modes comprises a time component.

11. The method of any of the statements 1-10, wherein the at least one flight path comprises a plurality of waypoints.

12. The method of any of the statements 1-11, wherein at least one waypoint of the plurality of waypoints comprises a time component.

13. An apparatus for multi-objective mission execution for an unmanned aerial vehicle (UAV), the apparatus comprising: a processor; and a non-transitory computer readable medium storing instructions that when executed by the processor, cause the apparatus to carry out operations including: detecting a mode change event associated with a UAV executing a mission in a first mission mode; determining based on the mode change event, a second mission mode for the UAV; and switching a current mission mode of the UAV from the first mission mode to the second mission mode.

14. The apparatus of statement 13, wherein detecting, by a computing device, a mode change event associated with a UAV executing a mission in a first mission mode includes: determining that a particular type of object is within a range of a sensor of the UAV.

15. The apparatus of any of the statements 13-14, wherein detecting, by a computing device, a mode change event associated with a UAV executing a mission in a first mission mode includes: receiving input indicating a change in mission modes.

16. The apparatus of any of the statements 13-15, wherein detecting, by a computing device, a mode change event associated with a UAV executing a mission in a first mission mode includes: detecting that the UAV is within a range of a particular physical location.

17. The apparatus of any of the statements 13-16, wherein the computer readable medium stores instructions that when executed by the processor cause the apparatus to carry out operations including: determining a plurality of mission modes for the UAV to perform during execution of the mission; generating at least one flight path linking the first mission mode of the plurality of mission modes to the second mission mode of the plurality of mission modes; and generating multi-objective mission route information including the at least one flight path and the plurality of mission modes of the UAV.

18. The apparatus of any of the statements 13-17, wherein detecting the mode change event associated with a UAV executing the mission in the first mission mode includes: determining that a particular type of object is within a range of a sensor of the UAV.

19. The apparatus of any of the statements 13-18, wherein detecting the mode change event associated with a UAV executing the mission in the first mission mode includes: receiving input indicating a change in mission modes.

20. The apparatus of any of the statements 13-19, wherein detecting the mode change event associated with a UAV executing the mission in the first mission mode includes: detecting that the UAV is within a range of a particular physical location.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for multi-objective mission execution for an unmanned aerial vehicle (UAV), the method comprising:
detecting, by a computing device, a mode change event associated with a UAV executing a mission in a first mission mode;
determining based on the mode change event, by the computing device, a second mission mode for the UAV; and
switching, by the computing device, a current mission mode of the UAV from the first mission mode to the second mission mode.

2. The method of claim 1, wherein detecting, by a computing device, a mode change event associated with a UAV executing a mission in a first mission mode includes: determining that a particular type of object is within a range of a sensor of the UAV.

3. The method of claim 1, wherein detecting, by a computing device, a mode change event associated with a UAV executing a mission in a first mission mode includes: receiving input indicating a change in mission modes.

4. The method of claim 1, wherein detecting, by a computing device, a mode change event associated with a UAV executing a mission in a first mission mode includes: detecting that the UAV is within a range of a particular physical location.

5. The method of claim 1, wherein the plurality of mission modes includes at least one of a free flight mission mode, a waypoint mission mode, a surveillance mission mode, and a follow mission mode.

6. A method for multi-objective mission planning for an unmanned aerial vehicle (UAV), the method comprising:
determining, by a computing device, a plurality of mission modes for a UAV to perform during execution of a mission;
generating, by the computing device, at least one flight path linking a first mission mode of the plurality of mission modes to a second mission mode of the plurality of mission modes; and
generating, by the computing device, multi-objective mission route information including the at least one flight path and the plurality of mission modes of the UAV.

7. The method of claim 6, further comprising, generating, by the computing device, an objective flight path for at least one of the plurality of mission modes.

8. The method of claim 7, wherein the objective flight path comprises a sweeping pattern of waypoints.

9. The method of claim 6, wherein the plurality of mission modes includes at least one of a free flight mission mode, a waypoint mission mode, a surveillance mission mode, and a follow mission mode.

10. The method of claim 6, wherein at least one of the plurality of mission modes comprises a time component.

11. The method of claim 6, wherein the at least one flight path comprises a plurality of waypoints.

12. The method of claim 11, wherein at least one waypoint of the plurality of waypoints comprises a time component.

13. An apparatus for multi-objective mission execution for an unmanned aerial vehicle (UAV), the apparatus comprising:
a processor; and
a non-transitory computer readable medium storing instructions that when executed by the processor, cause the apparatus to carry out operations including:
detecting a mode change event associated with a UAV executing a mission in a first mission mode;
determining based on the mode change event, a second mission mode for the UAV; and
switching a current mission mode of the UAV from the first mission mode to the second mission mode.

14. The apparatus of claim 13, wherein detecting, by a computing device, a mode change event associated with a UAV executing a mission in a first mission mode includes: determining that a particular type of object is within a range of a sensor of the UAV.

15. The apparatus of claim 13, wherein detecting, by a computing device, a mode change event associated with a UAV executing a mission in a first mission mode includes: receiving input indicating a change in mission modes.

16. The apparatus of claim 13, wherein detecting, by a computing device, a mode change event associated with a UAV executing a mission in a first mission mode includes: detecting that the UAV is within a range of a particular physical location.

17. The apparatus of claim 13 wherein the computer readable medium stores instructions that when executed by the processor cause the apparatus to carry out operations including:
determining a plurality of mission modes for the UAV to perform during execution of the mission;
generating at least one flight path linking the first mission mode of the plurality of mission modes to the second mission mode of the plurality of mission modes; and
generating multi-objective mission route information including the at least one flight path and the plurality of mission modes of the UAV.

18. The apparatus of claim 13, wherein detecting the mode change event associated with a UAV executing the mission in the first mission mode includes: determining that a particular type of object is within a range of a sensor of the UAV.

19. The apparatus of claim 13, wherein detecting the mode change event associated with a UAV executing the mission in the first mission mode includes: receiving input indicating a change in mission modes.

20. The apparatus of claim 13, wherein detecting the mode change event associated with a UAV executing the mission in the first mission mode includes: detecting that the UAV is within a range of a particular physical location.
